(19) United States
(12) Patent Application Publication
(10) Pub. No.: US 2016/0280053 A1
(43) Pub. Date: Sep. 29, 2016

(54) SEALING MEMBER FOR SLIDING DOOR, AND VEHICLE

(71) Applicant: MITSUBISHI HEAVY INDUSTRIES, LTD., Tokyo (JP)

(72) Inventor: Ichiro JOREN, Tokyo (JP)

(21) Appl. No.: 15/034,068

(22) PCT Filed: May 12, 2014
(86) PCT No.: PCT/JP2014/062587

§ 371 Date: May 3, 2016

(30) Foreign Application Priority Data
Nov. 14, 2013 (JP) 2013-235900

(51) Int. Cl. B60J 10/40; B61D 19/00; F16J 15/02

(52) U.S. Cl. CPC B60J 10/40; F16J 15/025; F16J 15/027; B61D 19/005

(57) ABSTRACT

A sealing member is disposed between a lateral surface of a vehicle body and a lateral sliding door supported by the vehicle body in such a way as to be capable of being slid along the lateral surface, between a closed position in which an opening of an entrance formed in the lateral surface is closed and an open position in which the opening is open. The sealing member includes a pressing plate attached to the lateral surface; an attachment portion clamped and fixed between the pressing plate and the lateral surface to which the pressing plate is attached, and having a hollow cylindrical shape extending in a vertical direction of the lateral sliding door; and a sealing portion provided integrally with the attachment portion, and contacting with door trailing edge rubber provided on the lateral sliding door while being in an elastically deformed state at the closed position.

### TECHNICAL FIELD

The present invention relates to a sealing member for a vehicle sliding door, and a vehicle including the sealing member for a sliding door.

Priorities of this application are claimed on Japanese Patent Application Publication No. 2013-235900, filed on Nov. 14, 2013, the content of which is incorporated herein by reference.

### BACKGROUND ART

A sliding door is provided in a vehicle body of a vehicle such as an electric train, and is slid to open and close an opening of an entrance (for example, refer to PTL 1). The sliding door allows passengers to board and disembark the vehicle by opening the opening when the vehicle stops at a station. The sliding door prevents passengers falling outside of the vehicle, and prevents infiltration of outside air or rainwater into the vehicle by closing the opening during traveling or the vehicle.

A gap is provided between the sliding door and a lateral surface of a vehicle body to allow the sliding door to be moved relative to the vehicle body. It is necessary to ensure quietness inside the vehicle by reducing infiltration of external noise into the vehicle in such a way as to prevent infiltration of outside air or rainwater into the vehicle through the gap in a state where the sliding door closes the opening. In the vehicle of the related art, door trailing edge rubber is attached to a door trailing edge of the sliding door, and a door trailing edge-rubber receiver is attached to the lateral surface of the vehicle body, and seals the gap between the sliding door and the lateral surface of the vehicle body by coming into contact with the door trailing edge rubber.

### CITATION LIST

### Patent Literature

[PTL 1] Japanese Unexamined Utility Model Registration Application Publication No. 63-169370

### SUMMARY OF INVENTION

### Technical Problem

Since a weight of passengers causes the occurrence of strain in the vehicle body, the gap between the sliding door and the vehicle body may be decreased. Accordingly, in a case where the door trailing edge-rubber receiver is not satisfactorily fixed to the sliding door, the door trailing edge-rubber receiver may be hooked to the sliding door during sliding of the sliding door, and the door trailing edge-rubber receiver may fall off.

The present invention provides a sealing member with a simple structure capable of ensuring sealability of a gap between a sliding door and a vehicle body, and a vehicle including the sealing member.

### Solution to Problem

According to a first aspect of the present invention, there is provided a sealing member for a sliding door disposed between a lateral surface of a vehicle body and a sliding door that is supported by the vehicle body in such a way as to be capable of being slid along the lateral surface between a closed position in which an opening of an entrance formed in the lateral surface is closed and an open position in which the opening is open, the sealing member including: a pressing plate extending in a vertical direction of the sliding door, and which is attached to of the sliding door and the lateral surface; an attachment portion that is clamped and fixed between the pressing plate and the one of the sliding door and the lateral surface to which the pressing plate is attached, and that has a hollow cylindrical interior; and a sealing portion that is provided integrally with the attachment portion to extend in the vertical direction of the sliding door, and comes into contact with a contact portion, which is provided on the other of the sliding door and the lateral surface, while being in an elastically deformed state at the closed position.

In such a sealing member, the attachment portion is formed into a hollow shape. For this reason, the pressing plate is capable of clamping the attachment portion by squeezing a hollow portion, and the sealing member can be provided on one of the sliding door and the lateral surface. Accordingly, it is possible to easily confirm the fixed state of the attachment portion with respect to the vehicle body by confirming the squeezed state of the attachment portion. Since the attachment portion has hollow cylindrical shape, it is possible to adjust a pressing force of the pressing plate applied to the attachment portion to the extent that the attachment portion does not fall off the vehicle body. As a result, it is possible to maintain a good fixed state of the sealing member, and to obtain sufficient sealing effects by bringing the sealing portion into contact with the contact portion.

The interior of the sealing portion may communicate with the interior of the attachment portion, and may be formed into a hollow cylindrical shape.

Since the sealing portion has a hollow cylindrical shape, when the sealing portion comes into contact with the contact portion, the sealing portion is more likely to be elastically deformed compared to a case in which the sealing portion is solid. Accordingly, even if a relative positional relationship between the sealing portion and the contact portion is changed due to an impact of strain of the vehicle body caused by a weight of passengers, it is possible to prevent the occurrence of partial contact between the sealing portion and the contact portion, and to obtain sufficient sealing effects. Since the sealing portion is formed integrally with the attachment portion, the sealing member has a hollow cylindrical shape in its entirety.

For this reason, the sealing member can be deformed to rotate around a central axis in an extending direction, which is the vertical direction of the sliding door, and is capable of more flexibly coping with a change in the relative positional relationship between the sealing portion and the contact portion. As a result, it is possible to obtain sufficient sealing effects.

In the sealing portion in which the sealing portion is formed into a hollow cylindrical shape, the attachment portion and the sealing portion may be made of hard rubber.

When the attachment portion and the sealing portion are made of hard rubber, it is possible to reduce an oil content of the attachment portion and the sealing portion, and to improve flame retardancy. In a case where the sealing portion is made of hard rubber, the amount of elastic deformation is decreased; however, since the sealing portion has a hollow cylindrical shape, the sealing portion is likely to be elastically deformed. As a result, it is possible to obtain sufficient sealing effects while improving flame retardancy.

According to a second aspect of the present invention, there is provided a vehicle including: a vehicle body configured to accommodate a transportation subject thereinside; a sliding door that is supported by the vehicle body in such a way as to be capable of being slid along a lateral surface of the vehicle body between a closed position in which an opening of an entrance formed in the lateral surface is closed and an open position in which the opening is open; and the sealing member for a sliding door which disposed between the lateral surface and the sliding door.

Since such a vehicle includes the sealing member including the hollow cylindrical attachment portion, it is possible to adjust a pressing force of the pressing plate applied to the attachment portion to the extent that the attachment portion of the sealing member does not fall off the vehicle body, to maintain a good fixed state of the sealing member, and to obtain sufficient sealing effects by bringing the sealing portion into contact with the contact portion.

### Advantageous Effects of Invention

In the sealing member for a sliding door and the vehicle, it is possible to ensure sealability of a gap between the sliding door and the vehicle body by forming the attachment portion into a hollow cylindrical shape which is a simple structure.

### BRIEF DESCRIPTION OF DRAWINGS

FIG. 1 is a side view of a vehicle in a first embodiment of the present invention.

FIG. 2 is an enlarged perspective view illustrating a lateral sliding door of the vehicle in the first embodiment of the present invention.

FIG. 3 is a sectional view perpendicular to a vertical direction of a vehicle body, illustrating the lateral sliding door and the vicinity of the lateral sliding door of the vehicle in the first embodiment of the present invention, and illustrates section A-A in FIG. 1.

FIG. 4A is a view illustrating the state of a sealing member before deformation in the vehicle according to the first embodiment of the present invention.

FIG. 4B is a view illustrating the state of the sealing member after deformation in the vehicle according to the first embodiment of the present invention.

FIG. 5 is a sectional view perpendicular to the vertical direction of a vehicle body, illustrating a lateral sliding door and the vicinity of the lateral sliding door of a vehicle in a second embodiment of the present invention.

### DESCRIPTION OF EMBODIMENTS

### First Embodiment

Hereinafter, a vehicle 1 in a first embodiment of the present invention will be described in detail with reference to the accompanying drawings.

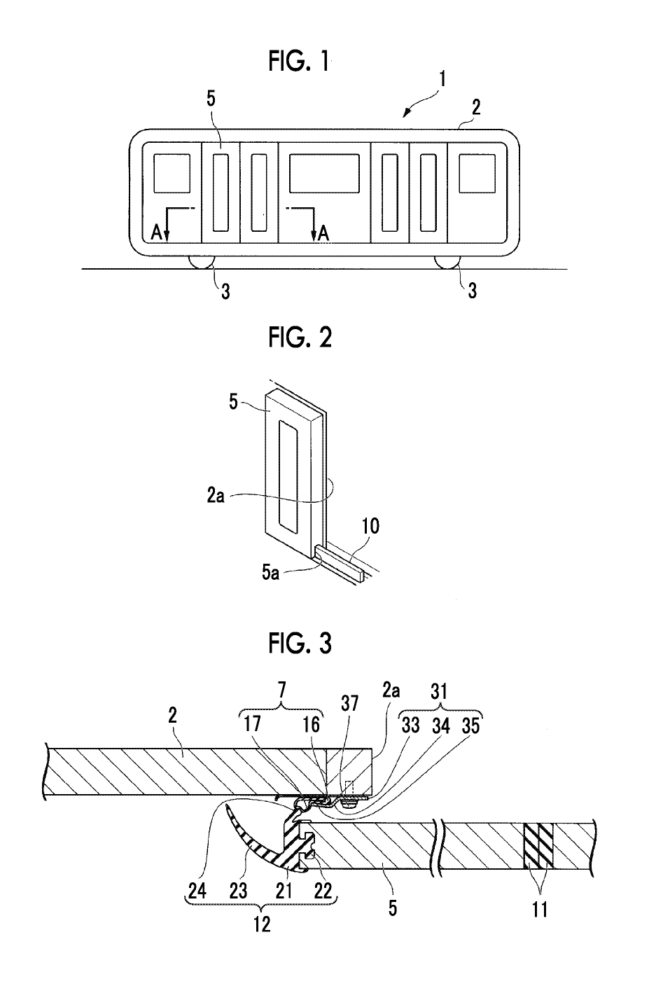

As illustrated in FIG. 1, the vehicle 1 includes a vehicle body 2 accommodating transportation subjects such as passengers thereinside; a traveling device 3 that is provided in a lower portion of the vehicle body 2 to travel the vehicle body 2; a lateral sliding door 5 provided in the vehicle body 2; and a sealing member 7 disposed between the vehicle body 2 and the lateral sliding door 5.

An opening 2a is formed in a lateral surface of the vehicle body and serves as an entrance for transportation subjects. In the embodiment, multiple openings 2a are formed in the vehicle body 2 while being apart away from each other in a travel direction of the vehicle body 2.

The lateral sliding door 5 is provided to be able to open and close the opening 2a of the vehicle body 2 from the outside of the lateral surface of the vehicle body 2. More specifically, a pair of the lateral sliding doors 5 is provided at each of the openings 2a. The pair of the lateral sliding doors is disposed in each of the openings 2a to face each other. The pair of the lateral sliding doors 5 is supported by the vehicle body 2 in such a way as to be capable of being slid by a door engine (not illustrated) provided on an upper portion of the vehicle body 2, and to approach and move away from each other.

Each of the lateral sliding doors 5 is supported and guided by lower rail 10 that is provided in a lower portion of the vehicle body 2 on the outside of the opening 2a at the formation position of the opening 2a. That is, each of the lateral sliding doors 5 is provided on the outside of the lateral surface of the vehicle body 2 and is formed of a so-called external suspended sliding door.

The lateral sliding doors are slid along the lateral surface of the vehicle body 2 between a closed position in which the lateral sliding doors 5 overlap the opening 2a of the vehicle body 2 such that the opening 2a s closed and an open position in which the lateral sliding doors 5 overlap the lateral surface of the vehicle body 2 at positions other than the formation position of the opening 2a such that the opening 2a is open.

Hereinafter, a movement direction refers to sliding direction of the lateral sliding door 5.

Door leading edge rubber 11 is provided at the door leading edges (tip portions through which the pair of the lateral sliding doors 5 come into contact with each other) of the lateral sliding doors 5 in such a way as to cover the full length of the door leading edges in a vertical direction of the lateral sliding door 5. The door leading edges of the pair of the lateral sliding doors 5 come into contact with each other at the closed position such that the opening 2a is closed.

Door trailing edge rubber (contact portion) 12 is provided at door trailing edges of the pair of the lateral sliding doors 5 opposite to the door leading edges in such a way as to cover the full length of the door trailing edges in the vertical direction of the lateral sliding door 5.

The door trailing edge rubber 12 includes a body portion 21 provided to cover an end surface of the door trailing edge of the lateral sliding door 5, and a fitting portion 22 that protrudes from the body portion 21 to the door trailing edge in the movement direction, and is fitted into a recessed portion. 5a formed by recessing a portion of the door trailing edge of the lateral sliding door 5 in the movement direction. The door trailing edge rubber 12 further includes a plate-shaped portion 23 which protrudes in the movement direction to become distant from the body portion 21 and the door trailing edge on an external surface side of the lateral sliding door 5, and gradually approaches the lateral surface of the vehicle body 2 as the plate-shaped portion 23 becomes distant from the door trailing edge. The door trailing edge rubber 12 further includes a facing portion 24 which protrudes from the body portion. 21 to approach the lateral surface of the vehicle body 2 on an inner surface side of the lateral sliding door 5, and includes an end portion having a circular section perpendicular to the vertical direction on a lateral surface side of the vehicle body 2.

In the embodiment, the facing portion 24 extends in an inclined manner toward a door leading edge side as the facing portion 24 becomes distant from the body portion 21.

Hereinafter, the sealing member 7 will be described.

As illustrated in FIG. 3, the sealing member 7 extends over the full length of the lateral sliding door 5 in the vertical direction, and is fixed to the lateral sliding door 5 in such a way as to be interposed between the vehicle body 2 and the lateral sliding door 5 and to face the door trailing edge rubber 12 when the lateral sliding door 5 is positioned at the closed position.

The sealing member 7 includes an attachment portion 16 that is fixed to the lateral sliding door 5 by a pressing plate 31 attached to the lateral sliding door 5, and a sealing portion 17 provided integrally with the attachment portion 16.

The attachment portion 16 a hollow cylindrical member made of hard rubber which is formed to have a rectangular section, and extends in the vertical direction of the lateral sliding door 5. The attachment portion. 16 may not be made of hard rubber but may be formed of an elastically deformable member, for example, the attachment portion 16 may be made of resin.

The sealing portion 17 is provided integrally with the attachment portion. 16 to extend in the vertical direction the lateral sliding door 5. The sealing portion 17 is formed to have the sectional shape of circle (a portion of a circle in the embodiment), and to have a hollow cylindrical shape which is made of a hard rubber material, similar to the attachment portion 16. An inner space of the sealing portion 17 communicates with an inner space of the attachment portion 16, and the sealing member 7 is formed of a single hollow member in its entirety. Similar to the attachment portion 16, the sealing portion 17 may not be made of hard rubber, but may be formed of an elastically deformable member, for example, the sealing portion 17 may be made of resin.

The sealing portion 17 is capable of coming into contact with the facing portion 24 of the door trailing edge rubber 12 when the lateral sliding door 5 is present at the closed position while the sealing portion 17 is elastically deformed. The sealing portion 17 is a member referred to as a so-called door trailing edge-rubber receiver.

In the embodiment, the pressing plate 31 for fixing the attachment portion 16 of the sealing member 7 includes a fixing plate portion 33 that is positioned closer to an opening 2a side than the attachment portion 16 of the sealing member 7, and is attached to the vehicle body 2 by using a bolt 37. In addition, the pressing plate 31 includes a bent plate portion 34 that is bent from the fixing plate portion 33 in such a way as to become distant from the lateral surface of the vehicle body 2, and extends in the movement direction in such a way as to become distant from the opening 2a. The pressing plate 31 includes a clamping plate portion 35 that is bent from the bent plate portion 34 in such a way as to approach the lateral surface of the vehicle body 2, and extends in the movement direction in such a way as to become distant from the opening 2a.

A tip of the clamping plate portion 35 is positioned in a connection portion between the attachment portion 16 and the sealing portion 17 of the sealing member 7, and bites into the portion such that the sealing member 7 is clamped and fixed between the clamping plate portion 35 and the lateral surface of the vehicle body 2.

The vehicle 1 includes the sealing member 7, and the attachment portion 16 of the sealing member 7 has a hollow cylindrical shape. For this reason, the attachment portion 16 can be fixed to the vehicle body 2 in such a way that the tip of the clamping plate portion 35 of the pressing plate 31 bites into the connection portion between the attachment portion 16 and the sealing portion 17, and the clamping plate portion 35 squeezes a hollow portion of the attachment portion 16.

Accordingly, it is possible to easily confirm the fixed state of the attachment portion 16 with respect to the vehicle body 2 by confirming the squeezed state of the attachment portion 16.

Since the attachment portion 16 has a hollow cylindrical shape, it is possible to adjust a pressing force of the pressing plate 31 applied to the attachment portion 16 to a desired magnitude such that the attachment portion 16 does not fall off the vehicle body 2. As a result, it is possible to maintain a good fixed state of the sealing member and to obtain sealing effects by bringing the sealing portion 17 into contact with the contact portion.

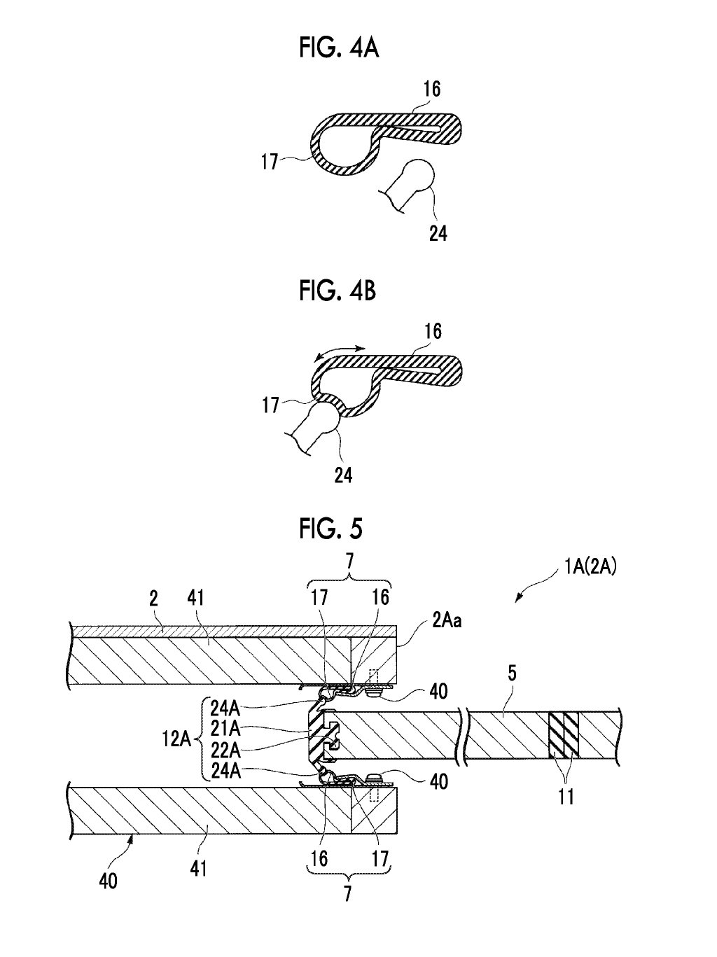

Since the sealing portion 17 has a hollow cylindrical shape, when the sealing portion 17 comes into contact with the door trailing edge rubber 12, the sealing portion is more likely to be elastically deformed compared to a case in which the sealing portion 17 is solid (refer to FIGS. 4A and 4B). Accordingly, even if positional relationship between the sealing portion 17 and the facing portion 24 of the door trailing edge rubber 12 is changed due to an impact of strain of the vehicle body 2 caused by a weight of passengers, it is possible to prevent the occurrence of partial contact between the sealing portion 17 and the door trailing edge rubber 12, and to obtain sufficient sealing effects.

Since the sealing portion 17 is formed integrally with the attachment portion the sealing member 7 has a hollow cylindrical shape in its entirety. For this reason, the sealing member 7 can be deformed to rotate around central axis in the vertical direction of the lateral sliding door 5 (rotate in a direction of the arrow in FIG. 4B), and is capable of more flexibly coping with a change relative positional relationship between the sealing portion 17 and the facing portion 24 of the door trailing edge rubber 12. As a result, it is possible to obtain sufficient sealing effects.

The sealing portion 17 further protrudes the lateral sliding door 5 than attachment portion 16. Accordingly, when the sealing portion 17 receives large force from the facing portion 24 of the door trailing edge rubber 12, the sealing member 7 is deformed such that the connection portion between the sealing portion 17 and the attachment portion 16 is bent. As a result, possible to maintain good contact state between the sealing member 7 and the door trailing edge rubber 12.

Since the attachment portion is made of hard rubber, it is possible to reduce an oil content of the attachment portion 16, and to improve flame retardancy. In a case where the attachment portion 16 is made of hard rubber, the amount of elastic deformation may be decreased compared to a case in which the attachment portion 16 is not made of hard rubber. However, since the attachment portion 16 has a hollow cylindrical shape, the attachment portion 16 is more likely to be elastically deformed compared to a case in which the attachment portion 16 is solid. As a result, the pressing plate 31 easily bites into the attachment portion 16, and it is possible to maintain a good fixed state of the sealing member 7 with respect to the vehicle body 2 even if the attachment portion 16 is made of hard rubber.

Similarly, since the sealing portion 17 of the sealing member 7 has a hollow cylindrical shape, and the sealing portion 17 is made of hard rubber, flame retardancy is improved, and when the sealing portion 17 comes into contact with the facing portion 24 of the door trailing edge rubber 12, the sealing portion is likely to be elastically deformed. As a result, it is possible to obtain sufficient sealing effects.

In the vehicle 1 of the embodiment, it is possible to ensure sealability of a gap between the lateral sliding door 5 and the vehicle body 2 by employing the sealing member 7 with a simple structure including the attachment portion 16 having a hollow cylindrical shape.

### Second Embodiment

Hereinafter, a vehicle 1A in a second embodiment of the present invention will be described.

The same reference signs will be assigned to the same configuration elements those in the first embodiment, and descriptions thereof will be omitted.

In the vehicle 1A of the embodiment, the structure of a vehicle body 2A is different from that of the vehicle body 2 in the first embodiment.

As illustrated in FIG. 5, door pocket portions 40 are provided on a lateral surface of the vehicle body 2A, and respectively accommodate the lateral sliding doors 5 on both sides of an opening 2Aa in a forward and rearward direction.

The door pocket portion 40 includes a pair of lateral plates 41 which are attached to the lateral surface of the vehicle body 2A while being apart from each other in a thickness direction of the lateral sliding door 5. When the lateral sliding door 5 is present at the open position, the entirety of the lateral sliding door 5 is interposed and accommodated between the lateral plates 41 in the thickness direction. When the lateral sliding door 5 is present at the closed position, the door trailing edge of the lateral sliding door 5 is interposed and accommodated therebetween in the thickness direction.

The attachment portion 16 of the sealing member 7 is clamped and fixed to the each of the lateral plates 41 of the door pocket portion 40 by the pressing plate 31 in such a way that the sealing portion 17 protrudes to the lateral sliding door 5.

Similar to the first embodiment, door trailing edge rubber (contact portion) 12A is provided at the door trailing edge of the lateral sliding door 5 in such a way as to cover the full length of the door trailing edge in the vertical, direction of the lateral sliding door 5.

The door trailing edge rubber 12A includes a body portion 21A provided to cover the end surface of the door trailing edge of the lateral sliding door 5, and a fitting portion. 22A that protrudes from the body portion 21A to the door trailing edge in the movement direction, and is fitted into the recessed portion 5a of the lateral sliding door 5. The door trailing edge rubber 12 further includes a pair of facing portions 24A which protrude from the body portion 21A on outer and inner surface sides of the lateral sliding door 5 in such a way as to respectively approach the lateral plates 41 of the door pocket portion 40, and each of which includes an end portion having a circular section perpendicular to the vertical direction on a lateral plate 41 side.

Each of the facing portions 24A has the same shape as that of each of the facing portions 24 of the door trailing edge rubber 12 in the first embodiment. The sealing portion 17 of the sealing member 7 is configured to come into contact with the facing portion 24A while being in an elastically deformed state when the lateral sliding door 5 is present at the closed position.

According to the aforementioned configuration, also, in a case where the vehicle 1A in the embodiment is a railway vehicle having a door pocket structure, it is possible to use the sealing member 7 including the attachment portion 16 having a hollow cylindrical shape, and to adjust a pressing force of the pressing plate 31 applied to the attachment portion 16 of the sealing member 7. Accordingly, it is possible to maintain a good fixed state of the sealing member 7, and it is possible to ensure sealability of a gap between the lateral sliding door 5 and the vehicle body 2A by bringing the sealing portion 17 into contact with the door trailing edge rubber 12A via a simple structure.

The embodiments of the present invention have been described in detail, and some design changes can be made insofar as the design changes do not depart from the technical concept of the present invention.

In the embodiments, the lateral sliding door 5 is provided with the door trailing edge rubber 12 (12A) including the facing portion (24A), and the vehicle body 2 (2A) is provided with the sealing member 7 including the sealing portion 17. Alternatively, the vehicle body 2 (2A) may be provided with a member including the facing portion 24, and the door trailing edge of the lateral sliding door 5 may be provided with the sealing member 7.

In the sealing member 7, the thickness dimension of the sealing portion 17 is set to a large value such that the sealing portion 17 further protrudes to the lateral sliding door 5 than the attachment portion 16. The sealing member 7 may have such a shape in a state where the sealing member 7 is attached to the vehicle body 2 (2A). That is, the sealing member 7 may be formed into a simple hollow cylindrical shape so as not to clearly differentiate the sealing portion 17 from the attachment portion 16 before the sealing member 7 is attached to the vehicle body 2 (2A).

The sealing portion 17 does not necessarily have a hollow cylindrical shape. Alternatively, a slit may be formed along the vertical direction, and a closed space may not be formed in the hollow portion. The sealing portion. 17 may be formed into a solid columnar shape.

The material of the attachment portion 16 may be different from that of the sealing portion 17.

In the cases described in the embodiments, the sealing member 7 is provided on the lateral sliding door 5 of the vehicle 1 (1A); however, the sealing member 7 can be applied to other doors of the vehicle 1 (1A) such as a corridor connection door.

### INDUSTRIAL APPLICABILITY

In the sealing member for a sliding door and the vehicle, it is possible to ensure sealability of the gap between the sliding door and the vehicle body by forming the attachment portion into a hollow cylindrical shape which is a simple structure.

### REFERENCE SIGNS LIST

1, 1A: VEHICLE
2, 2A: VEHICLE BODY
2a, 2Aa: OPENING
3: TRAVELING DEVICE
5: LATERAL SLIDING DOOR
5a: RECESSED PORTION
7: SEALING MEMBER
10: LOWER RAIL
11: DOOR LEADING EDGE RUBBER
12, 12A: DOOR TRAILING EDGE RUBBER (CONTACT PORTION)
16: ATTACHMENT PORTION
17: SEALING PORTION
21, 21A: BODY PORTION
22, 22A: FITTING PORTION
23: PLATE-SHAPED PORTION
24, 24A: FACING PORTION
31: PRESSING PLATE
33: FIXING PLATE PORTION
34: BENT PLATE PORTION
35: CLAMPING PLATE PORTION
37: BOLT
40: DOOR POCKET PORTION
41: LATERAL PLATE

1. A sealing member for a sliding door disposed between a lateral surface of a vehicle body and a sliding door that is supported by the vehicle body in such a way as to be capable of being slid along the lateral surface between a closed position in which an opening of an entrance formed in the lateral surface is closed and an open position in which the opening is open, the sealing member comprising:
a pressing plate extending in a vertical direction of the sliding door, and which is attached to one of the sliding door and the lateral surface;
an attachment portion that is clamped and fixed between the pressing plate and the one of the sliding door and the lateral surface to which the pressing plate is attached, and that has a hollow cylindrical interior; and
a sealing portion that is provided integrally with the attachment portion to extend in the vertical direction of the sliding door, and comes into contact with a contact portion, which is provided on the other of the sliding door and the lateral surface, while being in an elastically deformed state at the closed position.

2. The sealing member for a sliding door according to claim 1, wherein the interior of the sealing portion communicates with the interior of the attachment portion, and is formed into a hollow cylindrical shape.

3. The sealing member for a sliding door according to claim 2, wherein the attachment portion and the sealing portion are made of hard rubber.

4. A vehicle comprising:
a vehicle body configured to accommodate a transportation subject thereinside;
a sliding door that is supported by the vehicle body in such a way as to be capable of being slid along a lateral surface of the vehicle body between a closed position in which an opening of an entrance formed in the lateral surface is closed and an open position in which the opening is open; and
the sealing member for a sliding door according to claim 1 which is disposed between the lateral surface and the sliding door.
